(19) United States
(12) Patent Application Publication
(10) Pub. No.: US 2021/0055745 A1
(43) Pub. Date: Feb. 25, 2021

(54) CONTROLLER FOR UNMANNED AERIAL VEHICLE

(71) Applicant: LG ELECTRONICS INC., Seoul (KR)

(72) Inventors: Sanghak LEE, Seoul (KR); Pilwon KWAK, Seoul (KR); Daeun KIM, Seoul (KR); Jeongkyo SEO, Seoul (KR)

(73) Assignee: LG ELECTRONICS INC., Seoul (KR)

(21) Appl. No.: 16/799,066

(22) Filed: Feb. 24, 2020

(30) Foreign Application Priority Data
Aug. 22, 2019 (KR) 10-2019-0103218

(51) Int. Cl. G05D 1/08; B64C 39/02; G05D 1/10; G05D 1/00; G01P 15/18; G01C 19/56

(52) U.S. Cl. CPC G05D 1/0808; B64C 39/024; G05D 1/101; B64C 2201/146; G01P 15/18; G01C 19/56; B64C 2201/027; G05D 1/0011

(57) ABSTRACT

Provided is a controller for an unmanned aerial vehicle, including a control ball including a 3-axis acceleration sensor, a support unit for supporting the control ball so that the control ball is moved in position or rotated within a given range in a three-dimensional space, a processor for generating a control signal for controlling a motion of the unmanned aerial vehicle so that the unmanned aerial vehicle corresponds to a change in the 3-axis acceleration of the control ball, and a communication module for transmitting the control signal to the unmanned aerial vehicle. The present disclosure can be associated with an artificial intelligence module, a robot, an augmented reality (AR) device, a virtual reality (VR) device, and devices related to 5G service.

### CROSS-REFERENCE TO RELATED APPLICATIONS

This present application claims the priority benefit of Korean Application No. 10-2019-0103218, filed in the Republic of Korea on Aug. 22, 2019, the contents of which are all hereby incorporated by reference herein in their entirety into the present application for all purposes as fully set forth herein.

### BACKGROUND OF THE INVENTION

### Field of the Invention

The present disclosure relates to a controller for an unmanned aerial vehicle and, more particularly, to a controller for enabling a pilot to control an unmanned aerial vehicle more intuitively.

### Related Art

An unmanned aerial vehicle collectively refers to an unmanned aerial vehicle or an uninhabited aerial vehicle (UAV) having an airplane or helicopter shape, which can be aviated and controlled by the induction of radio waves without a pilot. Recently, the unmanned aerial vehicle is increasingly used in various civilian and commercial fields, such as image photographing, unmanned parcel delivery service, and disaster observation, in addition to military uses, such as reconnaissance and attacks.

A lot of time and training are necessary to control a controller that controls the unmanned aerial vehicle. Accordingly, there is a problem in using the unmanned aerial vehicle.

### SUMMARY OF THE INVENTION

The present disclosure provides a controller for an unmanned aerial vehicle, which can control an unmanned aerial vehicle more easily and intuitively.

In an aspect, a controller for an unmanned aerial vehicle includes a control ball including a 3-axis acceleration sensor, a support unit configured to support the control ball so that the control ball is moved in position or rotated within a given range in a three-dimensional space, a control module configured to generate a control signal for controlling a motion of the unmanned aerial vehicle so that the unmanned aerial vehicle corresponds to a change in the 3-axis acceleration of the control ball, and a communication module configured to transmit the control signal to the unmanned aerial vehicle.

The 3-axis acceleration sensor can sense the acceleration of gravity for three axes of the control ball and can obtain a roll and pitch of the control ball based on the sensed acceleration of gravity.

The control module can generate the control signal so that the roll and pitch of the unmanned aerial vehicle correspond to the roll and pitch of the control ball.

The control module can generate the control signal so that a change in the roll and pitch of the unmanned aerial vehicle for a unit time is proportional to a change in the roll and pitch of the control ball for a unit time.

The control ball can further include a gyro sensor for sensing angular velocities for three axes and obtaining a yaw of the control ball based on the sensed angular velocities.

The control module can generate the control signal so that a yaw of the unmanned aerial vehicle corresponds to the yaw of the control ball.

The control module can generate the control signal so that a change in the yaw of the unmanned aerial vehicle for a unit time is proportional to a change in the yaw of the control ball for a unit time.

The support unit can include a frame, a plurality of supports coupled to the frame, and wires configured to couple the control ball and the supports and to have elasticity.

The support unit can further include a pressure sensor for sensing a change in a tension of each of the wires based on a rotation and motion of the control ball.

The control module can generate the control signal corresponding to the change in the 3-axis acceleration only if there is a change in the pressure sensor.

The control module can generate the control signal if the location of the control ball is moved from an initial location and the control ball is rotated by an external force. The control module may not generate the control signal if the control ball returns to the initial location because an external force is removed.

The control module can generate the control signal so that a moving velocity of the unmanned aerial vehicle is proportional to a change in the tension of the wire.

The support unit can include a fixing connection unit fixed to the control ball and moved identically with a motion of the control ball, a plurality of first links coupled to the fixing connection unit and moved within a given radius range in response to a motion of the fixing connection unit, second links each coupled to each of the first links so that one end of the second link is rotated within a given radius, encoders each coupled to the other end of each of the second links and detecting a rotation angle of each of the second links, and a frame of a handle form to which the encoders are fixed.

The fixing connection unit can include a plurality of first fixed supports coupled to the control ball in a state in which the first fixed supports have been spaced apart at an identical interval on a single plane, clips coupled to the first fixed supports, respectively, each clip having an identical motion as a motion of the first fixed support, and a second fixed support configured to fix neighbor clips.

The control module can determine a moving direction of the control ball based on rotation angles of the second links obtained by the encoders, and can generate the control signal so that the unmanned aerial vehicle moves identically with the moving direction of the control ball.

The control module can generate the control signal corresponding to the change in the 3-axis acceleration only if at least any one of the second links is rotated.

The control module can generate the control signal if a location of the control ball is moved from an initial location and the control ball is rotated by an external force, and may not generate the control signal if the control ball returns to the initial location because the external force is removed.

The control module can generate the control signal so that a moving velocity of the unmanned aerial vehicle is proportional to the size of rotation angles of the second links detected by the encoders.

The control module can generate the control signal in accordance with a coordinate mode. If the coordinate mode is an absolute coordinate mode, the control module can consider the three axes of the control ball to be matched with earth-fixed coordinates regardless of a direction of the controller, and can generate the control signal.

If the coordinate mode is a relative coordinate mode, the control module can consider the three axes of the control ball to be matched with the controller, and can generate the control signal.

The controller can further include an indicator configured to indicate the state of the coordinate mode.

The controller can further include a gimbal operation unit configured to control a motion of a gimbal of the unmanned aerial vehicle. The gimbal operation unit can have a joystick form capable of moving in a 2-axis direction.

The controller can further include an indicator configured to indicate a photographing direction of the gimbal.

### BRIEF DESCRIPTION OF THE DRAWINGS

FIG. 1 is a perspective view illustrating an unmanned aerial vehicle according to an embodiment of the present disclosure.

FIG. 2 is a block diagram illustrating a control relation between major elements of the unmanned aerial vehicle of FIG. 1.

FIG. 3 is a block diagram illustrating a control relation between an aerial control system according to an embodiment of the present disclosure.

FIG. 4 is a block diagram illustrating the configuration of a controller for an unmanned aerial vehicle according to an embodiment of the present disclosure.

FIG. 5 is a perspective view illustrating a controller for an unmanned aerial vehicle according to an embodiment of the present disclosure.

FIG. 6 is a diagram illustrating the roll, pitch and yaw of a control ball.

FIGS. 7 and 8 are diagrams illustrating a method of controlling a horizontal movement of the unmanned aerial vehicle using a control ball.

FIG. 9 is a diagram illustrating a method of controlling a vertical movement of the unmanned aerial vehicle using a control ball.

FIG. 10 is a diagram illustrating a method of controlling the rotation of the unmanned aerial vehicle using a control ball.

FIG. 11 is a diagram illustrating control of a gimbal using a gimbal joystick.

FIG. 12 is a diagram illustrating an embodiment of an indicator.

FIGS. 13 and 14 are diagrams illustrating the conversion of coordinates of the controller.

FIGS. 15 to 17 are diagrams illustrating a controller according to another embodiment of the present disclosure.

### DESCRIPTION OF EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., can be used to describe various components, such components must not be limited by the above terms. The above terms are used only to distinguish one component from another.

When an element is “coupled” or “connected” to another element, it should be understood that a third element can be present between the two elements although the element can be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

The present application can include 5G generation (5th generation mobile communication) required by an apparatus and/or an AI processor that requires AI processed information.

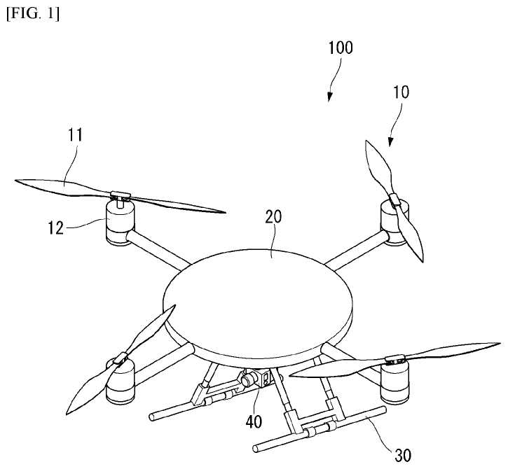

FIG. 1 shows a perspective view of an unmanned aerial vehicle according to an embodiment of the present invention.

First, the unmanned aerial robot 100 is manually manipulated by an administrator on the ground, or it flies in an unmanned manner while it is automatically piloted by a configured flight program. The unmanned aerial robot 100, as in FIG. 1, includes a main body 20, a horizontal and vertical movement propulsion device 10, and landing legs 30.

The main body 20 is a body portion on which a module, such as a task unit 40, is mounted.

The horizontal and vertical movement propulsion device 10 includes one or more propellers 11 positioned vertically to the main body 20. The horizontal and vertical movement propulsion device 10 according to an embodiment of the present invention includes a plurality of propellers 11 and motors 12, which are spaced apart. In this case, the horizontal and vertical movement propulsion device 10 can have an air jet propeller structure not the propeller 11.

A plurality of propeller supports is radially formed in the main body 20. The motor 12 can be mounted on each of the propeller supports. The propeller 11 is mounted on each motor 12.

The plurality of propellers 11 can be disposed symmetrically with respect to the main body 20. Furthermore, the rotation direction of the motor 12 can be determined so that the clockwise and counterclockwise rotation directions of the plurality of propellers 11 are combined. The rotation direction of one pair of the propellers 11 symmetrical with respect to the main body 20 can be set identically (e.g., clockwise). Furthermore, the other pair of the propellers 11 can have a rotation direction opposite (e.g., counterclockwise) that of the one pair of the propellers 11.

The landing legs 30 are disposed with being spaced apart at the bottom of the main body 20. Furthermore, a buffering support member (not shown) for minimizing an impact attributable to a collision with the ground when the unmanned aerial robot 100 makes a landing can be mounted on the bottom of the landing leg 30. The unmanned aerial robot 100 can have various aerial vehicle structures different from that described above.

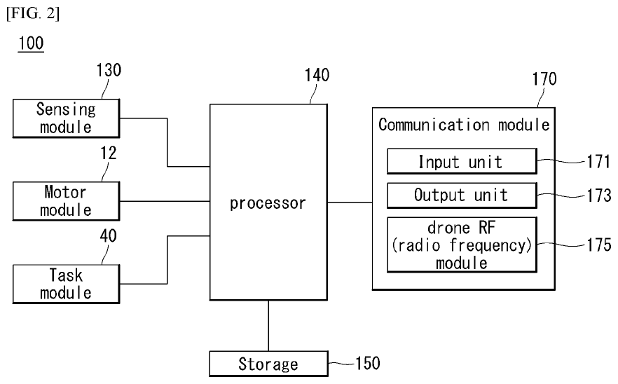

FIG. 2 is a block diagram showing a control relation between major elements of the unmanned aerial vehicle of FIG. 1.

Referring to FIG. 2, the unmanned aerial robot 100 measures its own flight state using a variety of types of sensors in order to fly stably. The unmanned aerial robot 100 can include a sensing module 130 including at least one sensor and a motor 12, the motor 12 can be a motor module 12.

The flight state of the unmanned aerial robot 100 is defined as rotational states and translational states.

The rotational states mean “yaw”, “pitch”, and “roll.” The translational states mean longitude, latitude, altitude, and velocity.

In this case, “roll”, “pitch”, and “yaw” are called Euler angles, and indicate that the x, y, z three axes of an aircraft body frame coordinate have been rotated with respect to a given specific coordinate, for example, three axes of NED coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (Ψ). If the front of an aircraft is rotated up and down on the basis of they axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (Φ).

The unmanned aerial robot 100 uses 3-axis gyroscopes, 3-axis accelerometers, and 3-axis magnetometers in order to measure the rotational states, and uses a GPS sensor and a barometric pressure sensor in order to measure the translational states.

The sensing module 130 of the present invention includes at least one of the gyroscopes, the accelerometers, the GPS sensor, the image sensor or the barometric pressure sensor. In this case, the gyroscopes and the accelerometers measure the states in which the body frame coordinates of the unmanned aerial robot 100 have been rotated and accelerated with respect to earth centered inertial coordinate. The gyroscopes and the accelerometers can be fabricated as a single chip called an inertial measurement module (IMU) using a micro-electro-mechanical systems (MEMS) semiconductor process technology. Furthermore, the IMU chip can include a microcontroller for converting measurement values based on the earth centered inertial coordinates, measured by the gyroscopes and the accelerometers, into local coordinates, for example, north-east-down (NED) coordinates used by GPSs.

The gyroscopes measure angular velocity at which the body frame coordinate x, y, z three axes of the unmanned aerial robot 100 rotate with respect to the earth centered inertial coordinates, calculate values (Wx.gyro, Wy.gyro, Wz.gyro) converted into fixed coordinates, and convert the values into Euler angles (Φgyro, θgyro, ψgyro) using a linear differential equation.

The accelerometers measure acceleration for the earth centered inertial coordinates of the body frame coordinate x, y, z three axes of the unmanned aerial robot 100, calculate values (fx,acc, fy,acc, fz,acc) converted into fixed coordinates, and convert the values into “roll (Φacc)” and “pitch (θacc).” The values are used to remove a bias error included in “roll (Φgyro)” and “pitch (θgyro)” using measurement values of the gyroscopes.

The magnetometers measure the direction of magnetic north points of the body frame coordinate x, y, z three axes of the unmanned aerial robot 100, and calculate a “yaw” value for the NED coordinates of body frame coordinates using the value.

The GPS sensor calculates the translational states of the unmanned aerial robot 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor can measure the altitude (hALP.baro) of the unmanned aerial robot 100. In this case, the subscript ALP means an air-level pressor. The barometric pressure sensor calculates a current altitude from a take-off point by comparing an air-level pressor when the unmanned aerial robot 100 takes off with an air-level pressor at a current flight altitude.

The camera sensor can include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP can generate a moving image including frames configured with a still image, in addition to a still image.

The unmanned aerial robot 100 includes a communication module 170 for inputting or receiving information or outputting or transmitting information. The communication module 170 can include a drone radio frequency (RF) module 175 for transmitting/receiving information to/from a different external device. The communication module 170 can include an input module 171 for inputting information. The communication module 170 can include an output module 173 for outputting information. The output module 173 can be omitted from the unmanned aerial robot 100, and can be formed in a terminal 300.

For example, the unmanned aerial robot 100 can directly receive information from the input module 171. For another example, the unmanned aerial robot 100 can receive information, input to a separate terminal 300 or server 200, through the drone RF module 175.

For example, the unmanned aerial robot 100 can directly output information to the output module 173. For another example, the unmanned aerial robot 100 can transmit information to a separate terminal 300 through the drone RF module 175 so that the terminal 300 outputs the information.

The drone RF module 175 can be provided to communicate with an external server 200, an external terminal 300, etc. The drone RF module 175 can receive information input from the terminal 300, such as a smartphone or a computer. The drone RF module 175 can transmit information to be transmitted to the terminal 300. The terminal 300 can output information received from the drone RF module 175.

The drone RF module 175 can receive various command signals from the terminal 300 and/or the server 200. The drone RF module 175 can receive area information for driving, a driving route, or a driving command from the terminal 300 and/or the server 200. In this case, the area information can include flight restriction area (A) information and approach restriction distance information.

The input module 171 can receive On/Off or various commands. The input module 171 can receive area information. The input module 171 can receive object information. The input module 171 can include various buttons or a touch pad or a microphone.

The output module 173 can notify a user of various pieces of information. The output module 173 can include a speaker and/or a display. The output module 173 can output information on a discovery detected while driving. The output module 173 can output identification information of a discovery. The output module 173 can output location information of a discovery.

The unmanned aerial robot 100 includes a processor 140 for processing and determining various pieces of information, such as mapping and/or a current location. The processor 140 can control an overall operation of the unmanned aerial robot 100 through control of various elements that configure the unmanned aerial robot 100.

The processor 140 can receive information from the communication module 170 and process the information. The processor 140 can receive information from the input module 171, and can process the information. The processor 140 can receive information from the drone RF module 175, and can process the information. The processor 140 can receive sensing information from the sensing module 130, and can process the sensing information.

The processor 140 can control the driving of the motor 12. The processor 140 can control the operation of the task module 40.

The unmanned aerial robot 100 includes a storage 150 for storing various data. The storage 150 records various pieces of information necessary for control of the unmanned aerial robot 100, and can include a volatile or non-volatile recording medium.

A map for a driving area can be stored in the storage 150. The map can have been input by the external terminal 300 capable of exchanging information with the unmanned aerial robot 100 through the drone RF module 175, or can have been autonomously learnt and generated by the unmanned aerial robot 100. In the former case, the external terminal 300 can include a remote controller, a PDA, a laptop, a smartphone or a tablet on which an application for a map configuration has been mounted, for example.

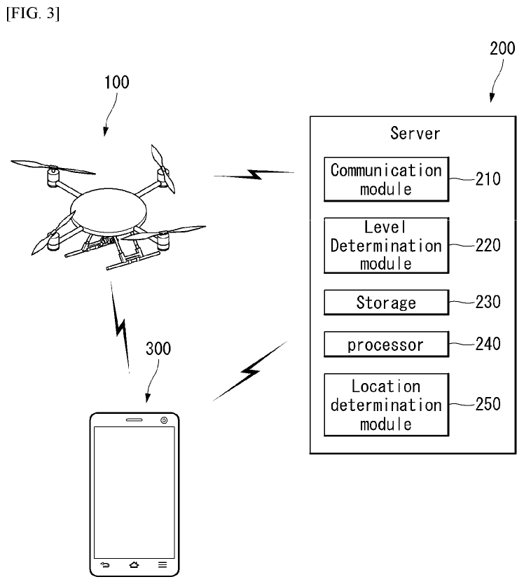

Referring to FIG. 3, the aerial control system according to an embodiment of the present invention can include the unmanned aerial robot 100 and the server 200, or can include the unmanned aerial robot 100, the terminal 300, and the server 200. The unmanned aerial robot 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. can be used as the wireless communication method.

A wireless Internet technology can be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

The terminal 300 can include a controller for receiving a control command for controlling the unmanned aerial robot 100 and an output unit for outputting visual or audio information.

The server 200 stores the information of the restricted flight area A, in which the flight of the unmanned flight robot 100 is restricted, and approaches the restricted flight area A according to the autonomous driving level of the unmanned flight robot 100. The limitation distance is calculated differently, and flight restriction area A information and access restriction distance information are provided to at least one of the unmanned aerial robot 100 and the terminal 300. Therefore, in the case of the unmanned aerial robot 100 having a high level for free driving, the unmanned aerial robot 100 having a low autonomous driving level is restricted in flight in the case of the unmanned aerial robot 100 having a low autonomous driving level. There is an advantage to prevent accidents that can occur in close proximity to zone A.

In addition, the server 200 sets a flight path based on the flight restriction area (A) information and the access restriction distance information, and provides the flight path to at least one of the unmanned flight robot 100 and the terminal 300. can do.

The server 200 can set a flight path based on the flight restriction area (A) information and the access restriction distance information according to the autonomous driving level, and control the unmanned flight robot 100 according to the flight path. have.

When the unmanned aerial robot 100 approaches within the access restriction distance, the server 200 can transmit a different command to the unmanned aerial robot 100 according to the autonomous driving level. The server 200 can transmit different commands to the unmanned aerial robot 100 whether the unmanned aerial robot 100 is automatically adjusted or manually adjusted.

For example, the server 200 can determine the autonomous driving level of the communication unit and the unmanned aerial robot 100 that exchange information with the unmanned aerial robot 100 and/or the terminal 300. Providing the information to the storage 230 and the unmanned aerial robot 100 and/or the terminal 300 for storing the flight restriction area (A) information is restricted flight of the unmanned aerial robot 100, or unmanned flight The robot 100 and/or the terminal 300 can include a processor 240 for controlling. In addition, the server can further include a location determination module 250 that determines the position and altitude of the unmanned aerial robot 100 based on the position altitude information provided by the unmanned aerial robot 100.

The storage 230 stores information on the flight restricted area A for air control, stores information on the autonomous driving level of the unmanned aerial robot 100, and stores the other information of the unmanned aerial robot 100 and information about air traffic control.

The level determining module 220 determines the autonomous driving level of the unmanned aerial robot 100. The autonomous driving level of the unmanned aerial robot 100 is determined based on the autonomous driving level information transmitted from the unmanned aerial robot 100 to the server 200, or is determined by the autonomous driving level information provided from the terminal 300.

The autonomous driving level of the unmanned aerial robot 100 is defined as level 1 as a level capable of fully manual driving only or that assists manual driving with various sensors, and the unmanned aerial robot 100 runs semi-autonomous (automatic landing and landing), level 2 involves passive obstacle avoidance, using a user-specified path, and level 3 involves the unmanned aerial robot 100 driving fully autonomously (generally generates a path and moves to the destination S2) and performs a task on its own (i.e., not a user-specified task).

The processor 240 calculates a different access restriction distance of the restricted flight area A according to the autonomous driving level of the unmanned aerial robot 100, and controls the unmanned aerial robot 100 and/or the terminal 300. It provides flight restricted area (A) information and access restriction distance information.

The information of the restricted flight area A can include location information of the restricted flight area A and boundary information of the restricted flight area A. FIG.

Here, providing the information of the processor 240 to the unmanned aerial robot 100 and/or the terminal 300 is the unmanned aerial robot 100 and/or the terminal to provide the information data in a wireless communication method such as 5G It means to transmit to 300.

According to an embodiment of the present disclosure, the unmanned aerial robot 100 can be controlled using a controller directly controlled by an operator in addition to the processor 240 of the server 200.

Embodiments of a controller are described below.

Controller for Unmanned Aerial Vehicle.

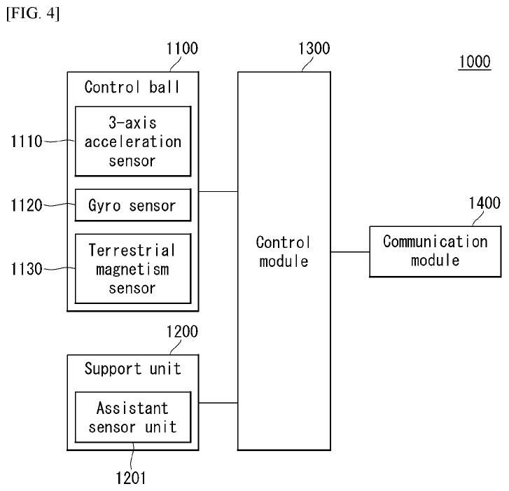

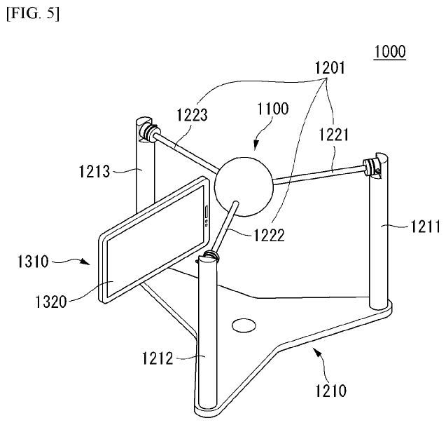

FIG. 4 is a block diagram illustrating the configuration of a controller for an unmanned aerial vehicle according to an embodiment of the present disclosure. FIG. 5 is a perspective view illustrating a controller for an unmanned aerial vehicle according to an embodiment of the present disclosure.

Referring to FIGS. 4 and 5, a controller for an unmanned aerial vehicle (hereinafter referred to as a “controller”) 1000 according to an embodiment of the present disclosure includes a control ball 1100, an assistant sensor unit 1201, a control module (i.e., processor or CPU) 1300, and a communication module 1400. The assistant sensor unit 1201, the control module 1300, and the communication module 1400 can be mounted on a control box 1310, as illustrated in FIG. 5.

The control ball 1100 can include sensors mounted on the unmanned aerial robot 100. That is, the control ball 1100 can include a 3-axis acceleration sensor 1110, a gyro sensor 1120, and a terrestrial magnetism sensor 1130.

The control ball 1100 can obtain the roll, pitch and yaw of the control ball using the sensors.

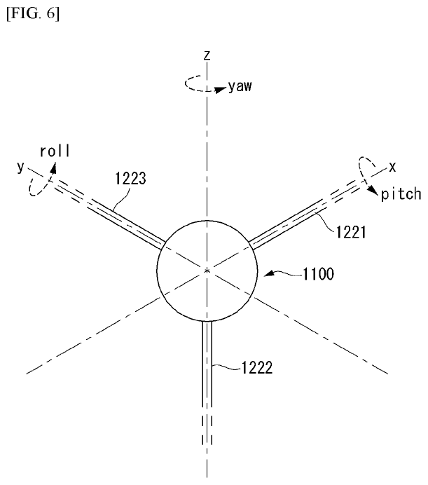

FIG. 6 is a diagram illustrating the roll, pitch and yaw of a control ball.

Like the acceleration sensor belonging to the unmanned aerial vehicle, the 3-axis acceleration sensor 1110 can sense the acceleration of gravity of the control ball 1100 and obtain the roll and pitch of the control ball 1100 based on the sensed acceleration of gravity. The yaw of the control ball 1100 can be obtained with reference to a sensing value of the gyro sensor 1120 or the terrestrial magnetism sensor 1130. The roll refers to the rotation of the control ball 1100 with respect to an X axis. The pitch refers to the rotation of the control ball 1100 with respect to a Y axis. The yaw refers to the rotation of the control ball 1100 with respect to a Y axis. In this case, the X axis and the Y axis refer to axes that are perpendicular to the Z axis, that is, the direction of the acceleration of gravity, and are orthogonal to each other.

The gyro sensor 1120 detects angular velocities at which the three X, Y and Z axes of the control ball 1100 rotate around earth inertial coordinates, calculates values converted into fixed coordinates, and obtains an Euler angle (or Euler angles) based on the calculated values.

The terrestrial magnetism sensor 1130 detects the directions of the three X, Y and Z axes of the control ball 1100 for a magnetic north point, and calculates a “yaw” value for the NED coordinates of the control ball 1100 using the detected directions.

A support unit 1200 mounts the control module 1300 and the communication module 1400, and supports the control ball 1100 so that the control ball is maintained at a given location in a three-dimensional space. In particular, the support unit 1200 supports the control ball 1100 so that the control ball is moved on a three dimension and horizontally moved within a given range by an external force. Furthermore, the support unit 1200 is implemented so that the control ball 1100 returns to its initial location in the state in which an external force has been removed.

The support unit 1200 according to an embodiment includes a plate 1210, a plurality of supports 1211, 1212, and 1213, and wires 1221, 1222, and 1223. The supports 1211, 1212, and 1213 may be disposed on the plate 1210 and may project (i.e., extend) in a vertical direction. Each of supports 1211, 1212, and 1213 may be disposed on a respective edge surface plate 1210 and each of the wires 1221, 1222, and 1223 may have a first end connected to a respective one of the supports 1211, 1212, and 1213, and may have a second end connected to the control ball 1100 by any known means, such as a fastener. The supports 1211, 1212, and 1213 may be elastically connected to the control ball 1100 and may elastically deform in response to a force applied by a user.

The plate 1210 provides the space in which general elements of the controller 1000 are combined or disposed. For example, the plate 1210 provides the space in which the supports 1211, 1212, and 1213 and the control box 1310 are combined.

The supports 1211, 1212, and 1213 are spaced apart in the plate 1210 at given intervals. Each of the supports 1211, 1212, and 1213 is coupled to any one of the wires 1221, 1222, and 1223. Two or more supports can be disposed. If the number of supports is too many (i.e., too great), it is advantageous for maintaining the control ball 1100 in a given location, but requires more force from an operator to control of the control ball 1100. Accordingly, in order to maintain the stability of the control ball 1100 structurally and to facilitate control of the control ball 1100, the number of supports can be three, and each of the supports 1211, 1212, and 1213 can be positioned at a location corresponding to the vertex of a regular triangle (i.e., the plate 1210 may be in the form of a regular triangle, as illustrated in FIG. 5).

The first wire 1221 couples the first support 1211 and the control ball 1100. The second wire 1222 couples the second support 1212 and the control ball 1100. The third wire 1223 couples the third support 2113 and the control ball 1100. The wires 1221, 1222, and 1223 are made of an elastic material, and thus the rotation and location movement of the control ball 1100 can be performed by an external force. Furthermore, the wires 1221, 1222, and 1223 can return the control ball 1100 to its initial location using their restoring forces if an external force is removed.

Furthermore, the assistant sensor unit 1201 can include pressure sensors for sensing the tension of the wires 1221, 1222, and 1223. The pressure sensors can be mounted on (or in) the respective supports 1211, 1212, and 1213. The pressure sensors sense tension changes of the wires 1221, 1222, and 1223 in accordance with the rotation and location movement of the control ball.

The control box 1310 includes a display 1320, the control module 1300, and the communication module 1400.

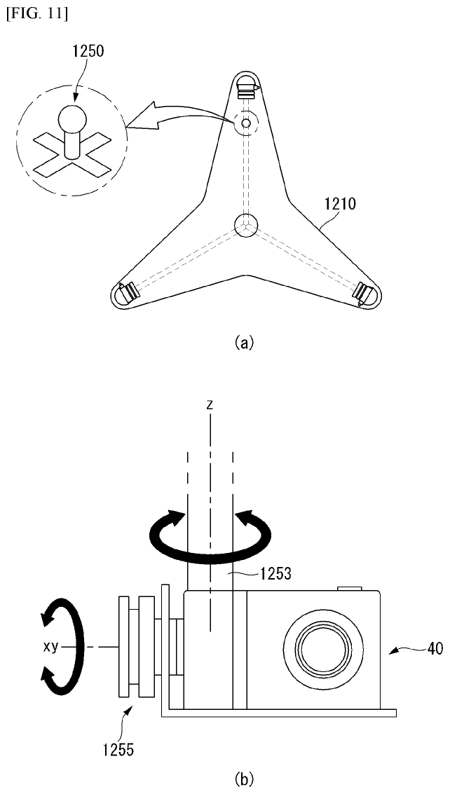

The display 1320 is positioned on one face of the control box 1310, and can display an image obtained by the gimbal 40 (see FIG. 11(b)) of the unmanned aerial robot 100 or an operation and control situation of the unmanned aerial robot 100.

The control module 1300 generates a control signal in accordance with motions of the sensors mounted on the control ball 1100. The control signal controls the motors 12 of the unmanned aerial robot 100 so that the unmanned aerial robot 100 moves identically with the moving direction of the control ball 1100. Furthermore, the control signal controls the motors 12 of the unmanned aerial robot 100 so that the unmanned aerial robot 100 is rotated in the same direction as the rotation direction of the control ball 1100. In order to generate the control signal, the control module 1300 can use the sensing results of the 3-axis acceleration sensor, the gyro sensor and the terrestrial magnetism sensor mounted on the control ball 1100, and can also use the sensing results of the pressure sensors mounted on the supports 1211, 1212, and 1213.

The communication module 1400 transmits a control signal, generated by the control module 1300, to the drone RF module 175 of the unmanned aerial robot 100.

A method of controlling the unmanned aerial vehicle using the controller is described below.

Method of Controlling Unmanned Aerial Vehicle Using Control Ball.

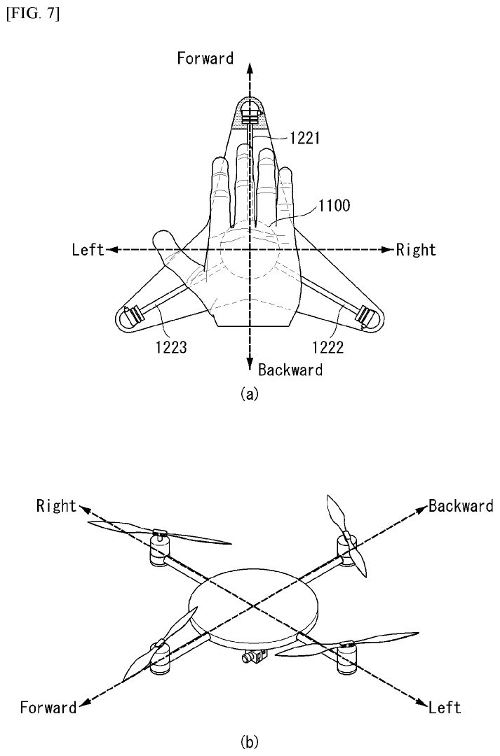

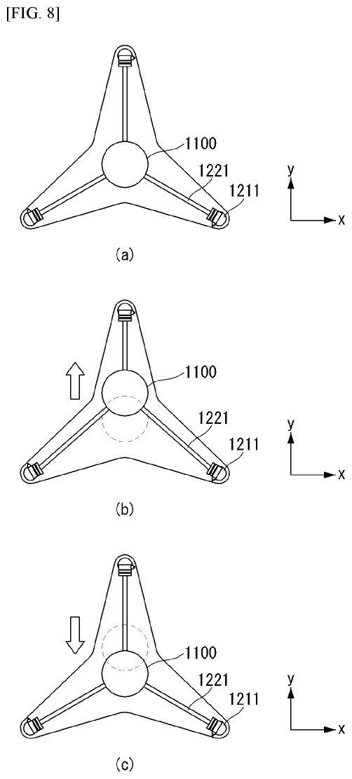

FIGS. 7 and 8 are diagrams illustrating a method of controlling a horizontal movement of the unmanned aerial vehicle using a control ball.

Referring to FIG. 7, the controller 1000 can horizontally move on a plane parallel to the surface of the earth.

If the control ball 1100 moves, tension changes occur in the first, second and third wires 1221, 1222 and 1223, and the pressure sensors can detect the tension changes. In this case, the size of the tension change of each of the first, second and third wires 1221, 1222 and 1223 is difference depending on the moving direction of the control ball 1100.

For example, if the control ball 1100 forwards with respect to an operator, tension changes in the same level occur in the second and third wires 1222 and 1223. In response thereto, the control module 1300 generates a control signal for moving the unmanned aerial robot 100 forward.

If the control ball 1100 moves to the right, the second wire 1222 has a relatively great tension change and the first and third wires 1221 and 1223 have relatively small tension changes. In response thereto, the control module 1300 generates a control signal for moving the unmanned aerial robot 100 to the right.

If the control ball 1100 moves backward, the first wire 1221 has a great tension change and the second and third wires 1222 and 1223 have small tension changes in the same level. In response thereto, the control module 1300 generates a control signal for moving the unmanned aerial robot 100 backward.

If the control ball 1100 moves to the left, the third wire 1223 has a relatively great tension change and the first and second wires 1221 and 1222 have small tension changes. In response thereto, the control module 1300 generates a control signal for moving the unmanned aerial robot 100 to the left.

Alternatively, the control ball 1100 includes an acceleration sensor capable of detecting a location movement on the plane. The control module 1300 can detect a motion of the control ball 1100 based on the sensing results of the acceleration sensor.

As described above, the control ball 1100 that has been horizontally moved by an external force, for example, an operator, returns to its initial location by the restoring forces of the wires 1221, 1222, and 1223.

The control module 1300 generates a control signal for only a location movement occurring in a process for the control ball 1100 to return. This is described below with reference to FIG. 8.

FIG. 8 is a diagram illustrating a motion of the control ball by an external force and a restoring force and the period in which a control signal is generated.

FIG. 8(a) is a diagram illustrating the location of the control ball in the state in which an external force has not been applied. In the state in which an external force has not been applied as in FIG. 8(a), the control ball 1100 maintains its initial location corresponding to the dead center of the supports 1211, 1212, and 1213 of the control ball 1100.

FIG. 8(b) is a diagram illustrating the location of the control ball in the state in which an external force has been applied. If the control ball 1100 is moved by an external force as in FIG. 8(b), the control module 1300 can generate a control signal in accordance with a change in the location of the control ball as described above.

FIG. 8(c) is a diagram illustrating that the control ball returns to its original location by an external force. If the control ball 1100 is returned because an external force is removed as in FIG. 8(c), the control module 1300 does not generate a control signal. A process for the control ball 1100 to return to its initial location can be determined to be a case where an operator's control intention is not present.

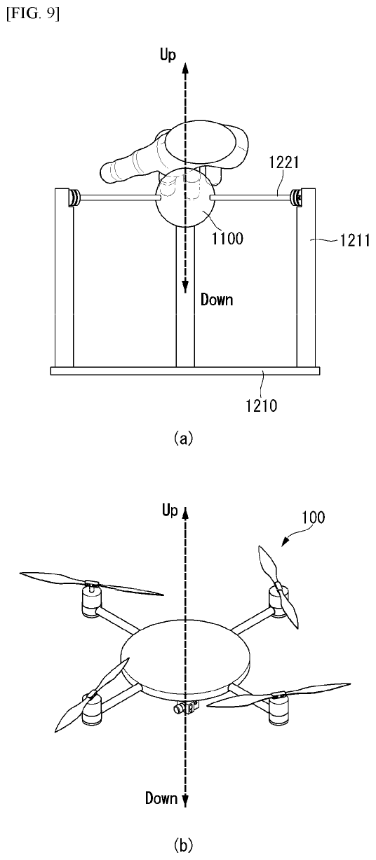

FIGS. 9(a) and 9(b) are diagrams illustrating a method of controlling a vertical movement of the unmanned aerial vehicle using a control ball.

Referring to FIG. 9(a), if the control ball 1100 vertically moves up, the first, second and third wires 1221, 1222 and 1223 are extended upward in the size of the same level. The pressure sensors detect that the tension of the first, second and third wires 1221, 1222 and 1223 is changed upward in the size of the same level. The control module 1300 can generate a control signal for vertically moving the unmanned aerial robot 100 in accordance with tension changes of the pressure sensors, as illustrated in FIG. 9(b).

If the control ball 1100 vertically moves down, the first, second and third wires 1221, 1222 and 1223 are downward extended in the size of the same level. The pressure sensors detect that the tension of the first, second and third wires 1221, 1222 and 1223 is changed downward in the size of the same level.

The control module 1300 can generate a control signal for vertically moving the unmanned aerial robot 100 in accordance with tension changes of the pressure sensors.

Even in the embodiment illustrated in FIGS. 9(a) and 9(b), the control module 1300 can generate a control signal only if the control ball 1100 deviates from its initial location, and may not generate a control signal while returns to the initial location.

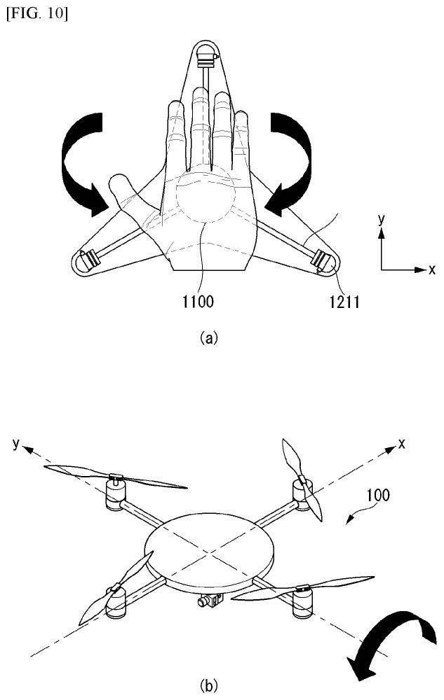

FIGS. 10(a) and 10(b) are diagrams illustrating a method of controlling the rotation of the unmanned aerial vehicle using the control ball.

Referring to FIG. 10(a), the control ball 1100 can rotate at a given radius without a location movement on a three dimension.

If the control ball 1100 rotates, the 3-axis acceleration sensor 1110 can detect a change in a 3-axis acceleration and obtain the roll and pitch of the control ball 1100 based on the change in the 3-axis acceleration. Furthermore, the control ball 1100 can obtain the yaw of the control ball 1100 using the gyro sensor 1120 or the terrestrial magnetism sensor 1130 in combination with the 3-axis acceleration sensor 1110. As a result, the sensors mounted on the control ball 1100 can obtain the rotation direction and the amount of rotation of the control ball 1100.

The control module 1300 can generate a control signal for rotating the unmanned aerial robot 100 identically with the rotation direction and the amount of rotation of the control ball 1100, as illustrated in FIG. 10(b).

Furthermore, the control module 1300 can generate a control signal so that a change in the roll and pitch of the unmanned aerial robot 100 for a unit time is proportional to a change in the roll and pitch of the control ball 1100 for a unit time. That is, the control module 1300 can control the rotation velocity of the unmanned aerial robot 100 so that it is proportional to a velocity at which the control ball 1100 rotates.

The control module 1300 generates a control signal for controlling the rotation of the unmanned aerial robot 100 only if there is a change in the pressure sensor. This is for preventing a control signal to control the rotation of the unmanned aerial robot 100 from being generated regardless of an operator's intention due to the tilt of the controller 1000 itself.

FIG. 11 is a diagram illustrating control of a gimbal using a gimbal joystick.

Referring to FIG. 11, a gimbal joystick 1250 can be formed on one face, for example, the bottom of the plate 1210.

The gimbal joystick 1250 can move in a first direction and second direction perpendicular to each other. If the gimbal joystick 1250 moves in the first direction, the control module 1300 generates a control signal for controlling the rotation of a Z-axis driver 1253. If the gimbal joystick 1250 moves in the second direction, the control module 1300 generates a control signal for controlling the rotation of an XY-axis driver 1255.

An operator can control the gimbal 40 more intuitively using the gimbal joystick 1250.

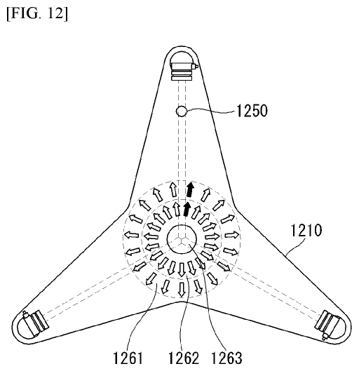

FIG. 12 is a diagram illustrating an embodiment of an indicator.

Referring to FIG. 12, the indicator includes a coordinate notification unit 1263, a gimbal heading indication unit 1261 and a drone heading indication unit 1262.

The drone heading indication unit 1261 indicates the heading direction of the unmanned aerial robot 100. The heading direction of the unmanned aerial robot 100 denotes the direction in which the unmanned aerial robot 100 aviates. The gimbal heading indication unit 1262 indicates the heading direction of the gimbal 40. The heading direction of the gimbal 40 denotes the direction in which the Z-axis driver 1253 or the XY-axis driver 1255 move. The coordinate notification unit 1263 indicates whether the controller 1000 is controlled based on absolute coordinates or relative coordinates.

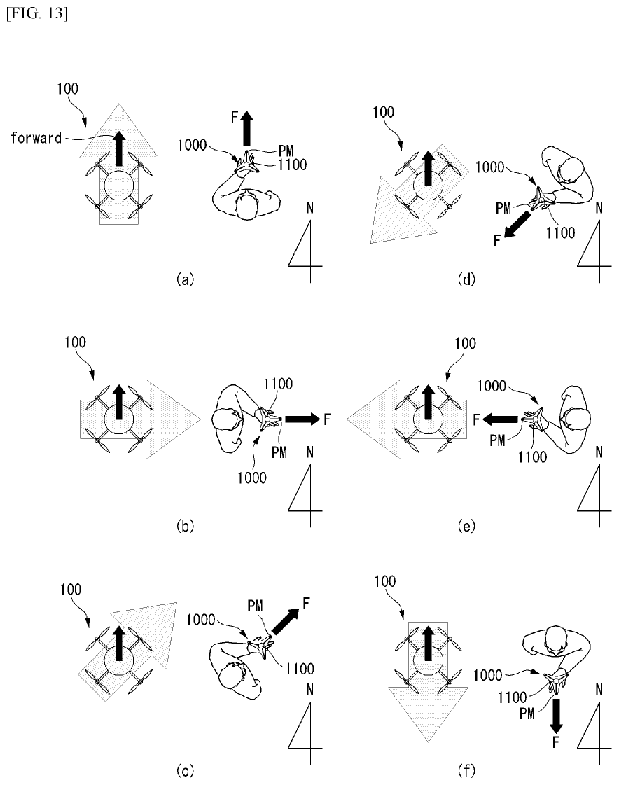

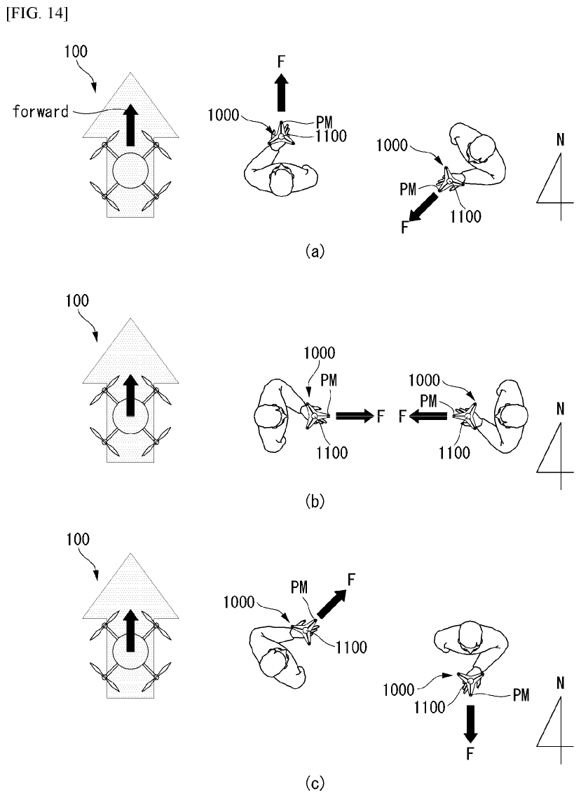

FIGS. 13 and 14 are diagrams illustrating the conversion of coordinates of the controller.

The control module 1300 can selectively set a coordinate mode. A button for selecting the coordinate mode can be positioned in a part of the control ball 1100 or the support unit 1200.

FIG. 13 is a diagram illustrating a control method if the unmanned aerial vehicle is in an absolute coordinate mode.

Referring to FIG. 13, if the coordinate mode is the absolute coordinate mode, the control module 1300 considers that the three axes of the control ball 1100 have been matched with earth-fixed coordinates regardless of a direction of the controller 1000. Accordingly, a control signal is generated based on the absolute location of the direction in which the control ball 1100 is moved by an external force F regardless of the direction toward which the controller 1000 is directed.

For example, if the control ball 1100 moves to the north as in FIG. 13(a), the control module 1300 generates a control signal so that the unmanned aerial robot 100 moves to the north. For example, if the control ball 1100 moves to the east as in FIG. 13(b), the control module 1300 generates a control signal so that the unmanned aerial robot 100 moves to the east regardless of a heading direction of the unmanned aerial robot 100. Likewise, if the control ball 1100 moves northeast as in FIG. 13(c), the control module 1300 generates a control signal so that the unmanned aerial robot 100 moves northeast. If the control ball 1100 moves southeast as in FIG. 13(d), the control module 1300 generates a control signal so that the unmanned aerial robot 100 moves southwest. Furthermore, if the control ball 1100 moves southwest as in FIG. 13(e), the control module 1300 generates a control signal so that the unmanned aerial robot 100 moves to the west. If the control ball 1100 moves to the south as in FIG. 13(f), the control module 1300 generates a control signal so that the unmanned aerial robot 100 moves to the south.

FIG. 14 is a diagram illustrating a control method if the unmanned aerial vehicle is in a relative coordinate mode.

Referring to FIG. 14, if the coordinate mode is in the relative coordinate mode, the control module 1300 can consider that the three axes of the control ball 1100 have been matched with the controller 1000, and can generate a control signal.

Accordingly, a control signal is generated in accordance with a direction within the controller 1000 regardless of the direction in which the control ball 1100 is moved by an external force F.

For example, although the control ball 1100 moves to the north or southwest on the bearing of the earth as in FIG. 14(a), if the control ball 1100 moves the forward direction of the controller 1000, the control module 1300 generates a control signal so that the unmanned aerial robot 100 moves forward.

Likewise, if the control ball 1100 moves in the forward direction of the controller 1000 regardless of the direction in which the control ball 1100 moves as in FIG. 14(b) or 14(c), the control module 1300 can generate a control signal so that the unmanned aerial robot 100 moves forward. That is, as long as the control ball 1100 moves forward with respect to the controller 1000, the control module 1300 will generate a control signal to move the unmanned aerial robot 100 forward (regardless of the direction of movement of the control ball 1100 with respect to an object or surface other than the controller 1000).

The directivity (i.e., direction) of the controller 1000 can be preset and can be indicated on one side of the controller 1000. For example, as in FIG. 14, a mark PM for indicating the forward direction of the controller 1000 can be formed in the controller 1000.

The forward direction of the unmanned aerial robot 100 is preset, and can correspond to the location where the gimbal 40 is positioned, for example, or the unmanned aerial robot 100 can include a mark for identifying directivity.

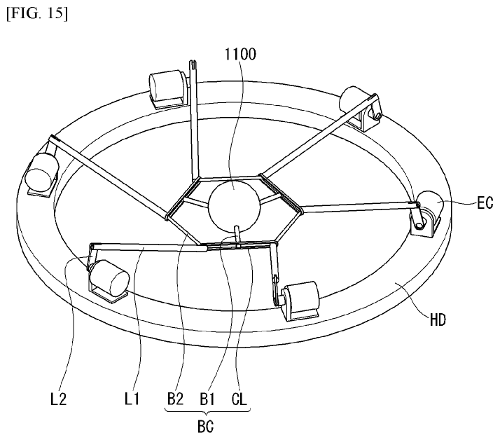

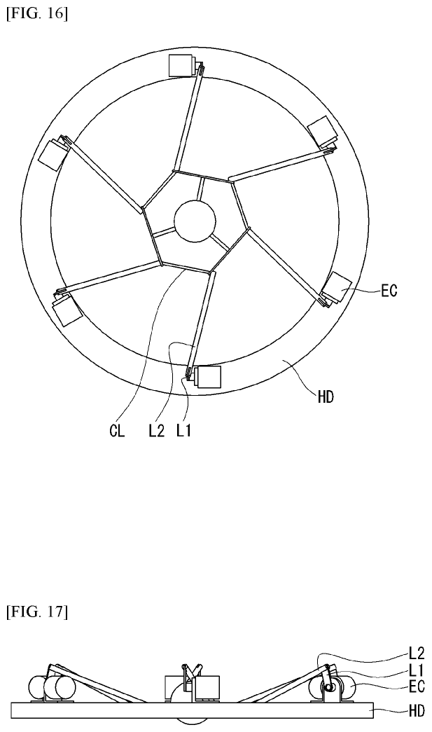

FIGS. 15 to 17 are diagrams illustrating a controller according to an embodiment of the present disclosure.

Referring to FIGS. 15 to 17, the controller 1000 according to an embodiment includes a control ball 1100, a frame HD having a handle form, a fixing connection unit BC, first links L1, second links L2 and encoders EC. The encoders EC may of any known type.

As in the above-described embodiment, the control ball 1100 can include the sensors mounted on the unmanned aerial robot 100. That is, the control ball 1100 can include the 3-axis acceleration sensor 1110, the gyro sensor 1120, and the terrestrial magnetism sensor 1130. The control ball 1100 can obtain its own roll, pitch and yaw using the sensors (the 3-axis acceleration sensor 1110, the gyro sensor 1120, and the terrestrial magnetism sensor 1130).

The fixing connection unit BC is fixed to the control ball 1100, and moves identically with a motion of the control ball 1100. The fixing connection unit BC includes first fixed supports B1, second fixed supports B2 and clips CL.

The first fixed supports B1 are fixed to the control ball 1100, and move in response to a motion of the control ball 1100. A plurality of the first fixed supports B1 is disposed. The first fixed supports B1 are spaced apart at the same intervals on a single plane.

The clip CL is coupled to the first fixed support B1, and moves in response to a motion of the first fixed support B1.

The second fixed support B2 fixes neighboring clips CL.

A link unit couples the fixing connection unit BC and the encoder EC so that the fixing connection unit BC directly coupled to the control ball 1100 maintains a constant location in the state in which an external force has not been applied to the fixing connection unit.

The link unit includes the first links L1 and the second links L2. The first link L1 is directly coupled to the clip CL, and has a motion within a given radius range of a point at which the first link L1 is coupled to the clip CL in response to a motion of the clip CL. One end of the second link L2 is coupled to the first link L1 in such a way to rotate at a given radius, and the other end thereof is coupled to the encoder EC.

The encoders EC are positioned in the frame HD and coupled to the second links L2 in a one-to-one way. The encoder EC detects the rotation angle of the second link L2.

The control module 1300 generates a control signal based on rotation angles of the encoder EC. For example, an included angle between the first and second links L1 and L2 is different and the rotation angle of each of the second links L2 is also different depending on the direction in which the control ball 1100 moves. The control module 1300 detects the moving direction of the control ball 1100 based on the rotation angle of each of the second links L2, and can generate a control signal corresponding to the detected moving direction.

Furthermore, in a process of controlling the rotation operation of the unmanned aerial robot 100 using the sensors (the 3-axis acceleration sensor 1110, the gyro sensor 1120, and the terrestrial magnetism sensor 1130) mounted on the control ball 1100, the control module 1300 generates a control signal for controlling the rotation of the unmanned aerial robot 100 only if the rotation angles of the second links L2 detected by the encoders EC are changed. This is for preventing a control signal to control the rotation of the unmanned aerial robot 100 from being generated regardless of an operator's intention due to the tilt of the controller 1000 itself. In other words, according to the present invention, only tilting of the controller 1000 itself will not generate a control signal, but movement of the control ball 1100 is required to generate a control signal.

Although not illustrated, a display, a manipulation unit, and an indicator can be coupled to the frame HD as in the controller illustrated in FIG. 5.

According to an embodiment of the present disclosure, the same sensors as those mounted on the unmanned aerial vehicle are mounted on the control ball of the controller, and the control ball and the unmanned aerial vehicle can be controlled identically by controlling the location and rotation of the control ball. Accordingly, an operator can easily control the unmanned aerial vehicle in an intuitive way.

The elements described in this specification should not be construed as being limitative from all aspects, but should be construed as being illustrative. The scope of the present disclosure should be determined by reasonable analysis of the claims, and all changes within the equivalent range of the present disclosure are included in the scope of the present disclosure.

What is claimed is:

1. A controller assembly for controlling an unmanned aerial vehicle, the controller assembly comprising:
a control ball comprising a 3-axis acceleration sensor;
a support assembly configured to support the control ball so that the control ball is moved in position or rotated within a given range in a three-dimensional space;
a processor configured to generate a control signal for controlling a motion of the unmanned aerial vehicle to correspond to a change in a 3-axis acceleration of the control ball; and
a communication module configured to transmit the control signal from the controller to the unmanned aerial vehicle.

2. The controller assembly of claim 1, wherein the 3-axis acceleration sensor senses an acceleration of gravity for three axes of the control ball and obtains a roll and pitch of the control ball based on the sensed acceleration of gravity.

3. The controller assembly of claim 2, wherein the processor generates the control signal to control the roll and pitch of the unmanned aerial vehicle to correspond to the roll and pitch of the control ball.

4. The controller assembly of claim 3, wherein the processor generates the control signal to control a change in the roll and pitch of the unmanned aerial vehicle for a unit time to be proportional to a change in the roll and pitch of the control ball for the unit time.

5. The controller assembly of claim 1, wherein the control ball further comprises a gyro sensor for sensing angular velocities for three axes of the control ball and obtaining a yaw of the control ball based on the sensed angular velocities.

6. The controller assembly of claim 5, wherein the processor generates the control signal to control a yaw of the unmanned aerial vehicle to correspond to the yaw of the control ball.

7. The controller assembly of claim 6, wherein the processor generates the control signal to control a change in the yaw of the unmanned aerial vehicle for a unit time to be proportional to a change in the yaw of the control ball for the unit time.

8. The controller assembly of claim 1, wherein the support assembly comprises:
a frame;
a plurality of supports coupled to the frame; and
a plurality of wires, each wire having a first end coupled to the control ball and a second end coupled to a respective one of the supports, and
wherein each of the wires are configured to elastically deform in response to movement of the control ball.

9. The controller assembly of claim 8, wherein the support assembly further comprises a pressure sensor for sensing a change in a tension of each of the plurality of wires based on motion of the control ball.

10. The controller assembly of claim 9, wherein the processor generates the control signal to move the unmanned aerial vehicle to correspond to the change in the 3-axis acceleration of the control ball only in response to the pressure sensor sensing the change in tension of at least one of the plurality of wires.

11. The controller assembly of claim 9, wherein:
the processor generates the control signal when the control ball is moved from an initial first position to a second position and the control ball is rotated, due to an external force from a user, and
the processor does not generate the control signal when the control ball returns to the initial first position due to the external force from the user being removed.

12. The controller assembly of claim 9, wherein the processor generates the control signal to control a moving velocity of the unmanned aerial vehicle to be proportional to a change in the tension of at least one of the plurality of wires.

13. The controller assembly of claim 1, wherein the support assembly comprises:
a frame;
a fixing connection fixed to the control ball and configured to move in response to motion of the control ball;
a plurality of first links coupled to the fixing connection and moved within a predetermined radius range in response to motion of the fixing connection;
a plurality of encoders fixed to the frame; and
a plurality of second links, each second link having a first end coupled to a respective one of the first links and a second end coupled to a respective one of the encoders,
wherein each second link is configured to rotate in response to movement of the respective first link, and
wherein each of the plurality of encoders are configured to detect a rotation angle of the respective second link.

14. The controller assembly of claim 13, wherein the fixing connection comprises:
a plurality of first fixed supports coupled to the control ball, the first fixed supports being spaced apart from each other by a predetermined interval on a single plane;
a plurality of clips, each clip being coupled to a respective one of the first fixed supports and being coupled to two respective first links among the plurality of first links, wherein each clip is configured to move in response to motion of the respective first fixed support; and
a plurality of second fixed supports, each second fixed support being fixed to two of the plurality of clips.

15. A controller assembly for controlling an unmanned aerial vehicle, the controller assembly comprising:
a support assembly;
a control ball suspended by the support assembly and comprising a sensor, the control ball being configured to:
move along 3-axes from an initial first position in response to a force applied by a user, and
return to the initial first position when the force applied by the user is removed;
a processor configured to generate a control signal for controlling motion of the unmanned aerial vehicle to directly correspond to motion of the control ball, due to the force applied by the user; and
a communication module configured to transmit the control signal from the controller to the unmanned aerial vehicle.

16. The controller assembly of claim 15, wherein the support assembly comprises:
a frame;
a fixing connection fixed to the control ball and configured to:
move in response to motion of the control ball, and
return the control ball to the initial first position in response to the force from the user being removed due to an elastic force of the fixing connection;
a plurality of first links coupled to the fixing connection and configured to move in response to motion of the fixing connection;
a plurality of encoders fixed to the frame; and
a plurality of second links, each second link having a first end coupled to a respective one of the first links and a second end coupled to a respective one of the encoders, wherein each second link is configured to rotate in response to movement of the respective first link,
wherein each of the plurality of encoders are configured to detect a rotation angle of the respective second link, and
wherein in response to detection of a change in the rotation angle of at least one of the second links by the respective encoder, the processor is configured to generate the control signal.

17. The controller assembly of claim 16, wherein the processor generates the control signal to control a moving velocity of the unmanned aerial vehicle in proportion to the detected rotation angle of at least one second links detected by the respective encoder.

18. The controller assembly of claim 16, wherein sensor includes a 3-axis acceleration sensor that senses an acceleration of gravity for three axes of the control ball and obtains a roll and pitch of the control ball based on the sensed acceleration of gravity, and
wherein the processor generates the control signal to control the roll and pitch of the unmanned aerial vehicle to correspond to the roll and pitch of the control ball.

19. The controller assembly of claim 18, wherein the sensor further includes a gyro sensor for sensing angular velocities for three axes of the control ball and obtaining a yaw of the control ball based on the sensed angular velocities, and
wherein the processor generates the control signal to control a yaw of the unmanned aerial vehicle to correspond to the yaw of the control ball.

20. The controller assembly of claim 15, wherein the support assembly comprises:
a frame;
a plurality of supports coupled to the frame; and
a plurality of wires, each wire having a first end coupled to the control ball and a second end coupled to a respective one of the supports; and
a pressure sensor for sensing a change in tension of each of the plurality of wires based on motion of the control ball,
wherein each of the wires is configured to elastically deform in response to movement of the control ball, and
wherein the processor generates the control signal to move the unmanned aerial vehicle to correspond to a change in 3-axis acceleration of the control ball only in response to the pressure sensor sensing the change in tension of at least one of the plurality of wires.
